(19) United States
(12) Patent Application Publication
(10) Pub. No.: US 2025/0265881 A1
(43) Pub. Date: Aug. 21, 2025

(54) METHOD AND SYSTEM OF SENSOR-BASED SMART UNLOCKING OF A FIREFIGHTER AIR REPLENISHMENT SYSTEM

(71) Applicant: Rescue Air Systems, Inc., San Carlos, CA (US)

(72) Inventor: Anthony J. Turiello, Redwood City, CA (US)

(73) Assignee: Rescue Air Systems, Inc., San Carlos, CA (US)

(21) Appl. No.: 19/187,572

(22) Filed: Apr. 23, 2025

Related U.S. Application Data
(63) Continuation of application No. 18/103,498, filed on Jan. 31, 2023, now Pat. No. 12,315,317.
(60) Provisional application No. 63/356,996, filed on Jun. 29, 2022.
(60) Provisional application No. 63/357,145, filed on Jun. 30, 2022.

(51) Int. Cl. G07C 9/00; A62B 7/02; A62B 9/00

(52) U.S. Cl. CPC G07C 9/00896; A62B 7/02; A62B 9/006

(57) ABSTRACT

Disclosed are methods and a system of sensor-based smart unlocking of a firefighter air replenishment system. A safety system of an occupiable structure includes a breathable-air supply system to facilitate delivery of breathable air from a source of compressed air, and a fill station in a fire-rated evacuation area of the occupiable structure to supply the breathable air to an emergency personnel. The safety system also includes a smart lock associated with the breathable-air supply system to automatically unlock one or more location(s) of the breathable-air supply system usable by the emergency personnel to access the breathable air during an emergency state of the occupiable structure, and a sensor associated with the breathable-air supply system to detect the emergency state of the occupiable structure.

### CLAIM OF PRIORITY

This application claims the benefit of priority under 35 U.S.C. § 120 as a continuation of U.S. patent application Ser. No. 18/103,498, filed Jan. 31, 2023, titled METHOD AND SYSTEM OF SENSOR-BASED UNLOCKING OF A FIREFIGHTER AIR REPLENISHMENT SYSTEM, which is a conversion application of, and claims priority to, U.S. Provisional Patent Application No. 63/356,996 titled CLOUD-BASED FIREFIGHTING AIR REPLENISHMENT MONITORING SYSTEM, SENSORS AND METHODS filed on Jun. 29, 2022, and U.S. Provisional Patent Application No. 63/357,145 titled METHOD AND SYSTEM OF SENSOR-BASED SMART UNLOCKING OF A FIREFIGHTER AIR REPLENISHMENT SYSTEM filed on Jun. 30, 2022. The contents of each of the aforementioned applications are incorporated herein by reference in entirety thereof.

### FIELD OF TECHNOLOGY

This disclosure relates generally to firefighting systems and, more particularly, to a method and system of sensor-based smart unlocking of a firefighter air replenishment system.

### BACKGROUND

An emergency response team may be deployed to alleviate an emergency situation and/or rescue people in an occupiable structure (e.g., a building such as a mid and/or high-rise building, a large horizontal structure such as a big box retail store, a warehouse and/or a manufacturing plant, a tunnel, a wind turbine and/or a large marine vessel) that is affected by an accident. The emergency situation and/or the accident may include but is not limited to an event such as a fire, an explosion, a chemical attack, a terror attack, a subway accident, a mine collapse, a catastrophic event and a biological agent attack. During the emergency situation, the air quality in the occupiable structure may be compromised by smoke and/or inflammatory and/or toxic air, making it difficult for an emergency responder to breathe. The emergency response team may rely on a Firefighter Air Replenishment System (FARS) installed within the occupiable structure to access reliable and safe supply of breathable air.

The emergency response team may have difficulty accessing the safe, breathable air in the FARS installed within the occupiable structure as emergency fill panels thereof may be located inside a locked closet and/or a room for protection against unauthorized access and/or tampering. In the absence of instantaneous access provisions, the emergency response team may need to forcibly open the locked closet and/or the room located inside the occupiable structure to access the breathable air from the emergency fill panels, causing delays that may endanger lives.

### SUMMARY

Disclosed are a method and a system of sensor-based smart unlocking of a firefighter air replenishment system.

In one aspect, a safety system of an occupiable structure includes a breathable-air supply system to facilitate delivery of breathable air from a source of compressed air, and a fill station in a fire-rated evacuation area of the occupiable structure to supply the breathable air to an emergency personnel. The safety system also includes a smart lock associated with the breathable-air supply system to automatically unlock at one or more location(s) of the breathable-air supply system usable by the emergency personnel to access the breathable air during an emergency state of the occupiable structure, and a sensor associated with the breathable-air supply system to detect the emergency state of the occupiable structure.

The smart lock associated with the breathable-air supply system may automatically lock the one or more location(s) of the breathable-air supply system required by the emergency personnel to access the breathable air when the emergency state ends and a normal state of the occupiable structure is detected. The breathable-air supply system may be housed in an air storage sub-system appurtenant to the occupiable structure. A lock state and an unlock state of the smart lock is determined based on a sensory data of the sensor associated with the breathable-air supply system.

The one or more location(s) of the breathable-air supply system required by the emergency personnel to access the breathable air during the emergency state of the occupiable structure may include a video camera that captures a visual recording when the one or more location(s) is being accessed by anyone in the unlock state. The video camera may also record an audio communication ambient to the one or more location(s). The visual recording and/or the audio recording may be communicated to a remote fire command center, an onsite fire command center and/or a fire command room.

The breathable-air supply system may automatically transcribe the audio communication and/or the visual recording of the one or more location(s). The breathable-air supply system may automatically provide a situational awareness recommendation to the remote fire command center, the onsite fire command center and/or the fire command room using an artificial intelligence algorithm based on a regression analysis of the sensory data.

The sensor may include a carbon monoxide sensor, a carbon dioxide sensor, an oxygen level sensor, a nitrogen level sensor, a hydrocarbon sensor, a moisture sensor, and/or a pressure sensor. The carbon monoxide sensor may trigger the emergency state when a level of ambient carbon monoxide exceeds a first predetermined threshold value (e.g., 5 parts per million (ppm), 10 ppm). The carbon dioxide sensor may trigger the emergency state when a level of ambient carbon dioxide exceeds a second predetermined threshold value (e.g., 1000 ppm, 1200 ppm). The oxygen level sensor may trigger the emergency state when the ambient oxygen level falls outside a predetermined threshold range (e.g., between 19.5% and 23.5%) of values.

The nitrogen level sensor may trigger the emergency state when a level of nitrogen falls below a third predetermined threshold value (e.g., 75%) and/or rises above a fourth predetermined threshold value (e.g., 81%). The hydrocarbon sensor may trigger the emergency state when a condensed hydrocarbon content exceeds a fifth predetermined threshold value (e.g., 5 milligrams per cubic meter of air). The moisture sensor may trigger the emergency state when moisture concentration exceeds a sixth predetermined threshold value (e.g., 24 ppm by volume). The pressure sensor may trigger the emergency state when pressure falls below a seventh predetermined threshold value (e.g., 90 percent of the maintenance pressure specified in a fire code).

The one or more location(s) of the breathable-air supply system may include an exterior mobile air connection panel, an air monitoring closet, an air monitoring room, an air storage closet, an air storage room, a fire command center, a fire command room, a fire alarm panel, a computing device executing a software application thereon, a fill station of the occupiable structure and/or a temporarily established fill station connected to a compressed air source during the emergency state. The smart lock associated with the breathable-air supply system automatically unlocks each location of the breathable-air supply system usable during the emergency state of the occupiable structure. The fire-rated evacuation area of the occupiable structure may be a stairwell. The sensor associated with the breathable-air supply system may include an array of sensors.

In another aspect, a method of a safety system of an occupiable structure includes facilitating a breathable-air supply system to deliver breathable air from a source of compressed air, and supplying the breathable air to an emergency personnel through a fill station in a fire-rated evacuation area of the occupiable structure. The method also includes automatically unlocking a smart lock associated with the breathable-air supply system to permit entry to one or more location(s) of the breathable-air supply system usable by the emergency personnel to access the breathable air during an emergency state of the occupiable structure. Further, the method includes integrating a sensor within the breathable-air supply system to detect the emergency state based on a threshold level of an air quality parameter, and configuring the sensor to trigger an alert signal to automatically unlock the smart lock on the detection of the emergency state.

The method may also include automatically locking the one or more location(s) of the breathable-air supply system required by the emergency personnel to access the breathable air when the emergency state ends and a normal state of the occupiable structure is detected by the sensor, and recording, through a video camera, an audiovisual incident to communicate to a remote fire command center, an onsite fire command center and/or a fire command room through a cloud computing network, when the one or more location(s) is accessed by an unauthorized person and/or the emergency personnel in an unlock state of the smart lock.

The method may also include automatically providing, through the breathable-air supply system, a situational awareness recommendation to the remote fire command center, the onsite fire command center and/or the fire command room using an artificial intelligence algorithm based on a regression analysis of a sensory data of the sensor, and providing the sensor with a carbon monoxide sensor, a carbon dioxide sensor, an oxygen level sensor, a nitrogen level sensor, a hydrocarbon sensor, a moisture sensor and/or a pressure sensor.

The method may further include generating a trigger signal to alert the emergency personnel, the remote fire command center, the onsite fire command center and/or the fire command room based on detecting tampering of the smart lock associated with the breathable-air supply system. The one or more location(s) may include an exterior mobile air connection panel, an air monitoring closet, an air monitoring room, an air storage closet, an air storage room, a fire command center, a fire command room, a fire alarm panel, a computing device executing a software application thereon, a fill station of the occupiable structure and/or a temporarily established fill station connected to a compressed air source during the emergency state.

The smart lock associated with the breathable-air supply system may automatically unlock each location of the breathable-air supply system usable during the emergency state of the occupiable structure. The fire-rated evacuation area of the occupiable structure may be a stairwell. The sensor within the breathable-air supply system may include an array of sensors. Additionally, the method may include accessing the smart lock using a Radio Frequency Identification (RFID) system, a smart card, a key fob access, a Non-Fungible Token (NFT), a physical key, a biometric system and/or a web-based identification system.

Also, the method may include automatically triggering the emergency state using the carbon monoxide sensor when a level of ambient carbon monoxide exceeds a first predetermined threshold value (e.g., 5 parts per million (ppm), 10 ppm), automatically triggering the emergency state using the carbon dioxide sensor when a level of ambient carbon dioxide exceeds a second predetermined threshold value (e.g., 1000 ppm, 1200 ppm), and automatically triggering the emergency state using the oxygen level sensor when a level of ambient oxygen falls outside a predetermined range of values (e.g., between 19.5% and 23.5%). Additionally, the method may include automatically triggering the emergency state using the nitrogen level sensor when a level of nitrogen falls below a third predetermined threshold value (e.g., 75%) and when the level of nitrogen rises above a fourth predetermined threshold value (e.g., 81%), and automatically triggering the emergency state using the hydrocarbon sensor when a condensed hydrocarbon content exceeds a fifth predetermined threshold value (e.g., 5 milligrams per cubic meter of air).

Still further, the method may include automatically triggering the emergency state using the moisture sensor when a moisture concentration exceeds a sixth predetermined threshold value (e.g., 24 ppm by volume), and, automatically triggering the emergency state using the pressure sensor when a pressure falls below a seventh predetermined threshold value (e.g., 90 percent of the maintenance pressure specified in a fire code).

In yet another aspect, a method of a safety system of an occupiable structure includes facilitating a breathable-air supply system to deliver breathable air from a source of compressed air, and supplying the breathable air to an emergency personnel through a fill station in a fire-rated evacuation area of the occupiable structure. The method also includes automatically unlocking a smart lock associated with the breathable-air supply system to permit entry to each location of the breathable-air supply system usable by the emergency personnel to access the breathable air during an emergency state of the occupiable structure, and integrating a sensor within the breathable-air supply system to detect the emergency state based on a threshold level of an air quality parameter.

Further, the method also includes configuring the sensor to trigger an alert signal to automatically unlock the smart lock on the detection of the emergency state.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1is a schematic view of a safety system interpretable as a smart locking system of a breathable-air supply system, according to one embodiment.

FIG. 2 is a schematic view of the safety system of FIG. 1 in more detail, according to one embodiment.

FIG. 3 is a schematic and perspective view of the safety system of FIGS. 1-2 according to one embodiment.

FIG. 4 is a schematic view of an array of sensors of the breathable-air supply system of FIGS. 1-3, according to one embodiment.

FIG. 5A is a user interface view of a fire safety application executing on a computing device of the safety system of FIGS. 1 and 3, according to one embodiment.

FIG. 5B is another user interface view of the fire safety application of FIG. 5A, according to one embodiment.

FIG. 6 is a process flow diagram detailing the operations in a sensor-based smart unlocking of a firefighter air replenishment system, according to one embodiment.

Other features of the present embodiments will be apparent from the accompanying drawings and from the detailed description that follows.

### DETAILED DESCRIPTION

Example embodiments, as described below, may be used to provide methods and/or a system of a sensor-based smart unlocking of a firefighter air replenishment system. Although the present embodiments have been described with reference to specific example embodiments, it will be evident that various modifications and changes may be made to these embodiments without departing from the broader spirit and scope of the various embodiments.

In one embodiment, a safety system 150 of a building 308 (an example occupiable structure) includes a breathable-air supply system 102, a fill station (e.g., internal air fill station 202), a smart lock 118, and an array of sensors 104_{1-N}. The breathable-air supply system 102 facilitates the delivery of breathable air from a source of compressed air 170. The fill station (e.g., internal air fill station 202) in a fire-rated evacuation area 350 (e.g., a fire-rated stairwell) of building 308 supplies breathable air to an emergency personnel 122_{1-N}. The smart lock 118 associated with the breathable-air supply system 102 automatically unlocks one or more location(s) (e.g., locations 370 such as fire-rated evacuation area 350 and others to be discussed below) of the breathable-air supply system 102 usable by the emergency personnel 122_{1-N} to access the breathable air during an emergency state 380 of the building 308 The array of sensors 104_{1-N} associated with the breathable-air supply system 102 is configured to detect the emergency state 380 of the building 308.

The smart lock 118 may automatically lock the one or more location(s) 370 of the breathable-air supply system 102 when the emergency state 380 ends and a normal state 390 of the building 308 is detected. The breathable-air supply system 102 may be housed in an air storage sub-system (e.g., air storage system 206) appurtenant to the building 308. The smart lock 118 associated with the breathable-air supply system 102 may include a lock state 152 and an unlock state 154. The lock state 152 and the unlock state 154 of the smart lock 118 may be determined based on a sensory data 172 (e.g., shown as part of array of sensors 104_{1-N}) of the array of sensors 104_{1-N} within the breathable-air supply system 102.

The breathable-air supply system 102 may include a video camera 174 in the one or more location(s) 370 required by the emergency personnel 122_{1-N} to access the breathable air during the emergency state 380 of the building 308. The video camera 174 may capture a visual recording 142 when the one or more location(s) 370 is accessed by anyone in the unlock state 154 The video camera 174 may further record audio communication 144 ambient to the one or more location(s) 370. The visual recording 142 and/or the audio communication 144 may be communicated to a breathable air supply command center 110 (e.g., a remote fire command center, an onsite fire command center) and/or a fire command room (e.g., a fire control room 222). In addition, the breathable-air supply system 102 may automatically transcribe the audio communication 144 and/or the visual recording 142 of the one or more location(s) 370.

The breathable-air supply system 102 may automatically provide a situational awareness recommendation 146 to the a breathable air supply command center 110 and/or the fire command room. The situational awareness recommendation 146 may be provided by using an artificial intelligence algorithm 148 (e.g., executing as part of software module 116 of a cloud computing network 106) based on a regression analysis 160 of the sensory data 172

The array of sensors 104_{1-N} may include a carbon monoxide sensor 416, a carbon dioxide sensor 418, an oxygen level sensor 420, a nitrogen level sensor 422 a hydrocarbon sensor 424, a moisture sensor 426 and/or a pressure sensor 428 The carbon monoxide sensor 416 may trigger the emergency state 380 when a level of ambient carbon monoxide exceeds a first predetermined threshold value (e.g., 5 parts per million (ppm), 10 ppm). The carbon dioxide sensor 418 may trigger the emergency state 380 when a level of ambient carbon dioxide exceeds a second predetermined threshold value (e.g., 1000 ppm, 1200 ppm). The oxygen level sensor 420 may trigger the emergency state 380 when an ambient oxygen level falls outside a predetermined range of values (e.g., between 19.5% and 23.5%). The nitrogen level sensor 422 may trigger the emergency state 380 when a level of nitrogen falls below a third predetermined threshold value (e.g., 75%) and above a fourth predetermined threshold value (e.g., 81%). The hydrocarbon sensor 424 may trigger the emergency state 380 when a condensed hydrocarbon content exceeds a fifth predetermined threshold value (e.g., 5 milligrams per cubic meter of air). The moisture sensor 426 may trigger the emergency state 380 when moisture concentration exceeds a sixth predetermined threshold value (e.g., 24 ppm by volume). The pressure sensor 428 may trigger the emergency state 380 when pressure falls below a seventh predetermined threshold value (e.g., 90 percent of the maintenance pressure specified in a fire code).

The one or more location(s) 370 may include an exterior mobile air connection panel 214, an air monitoring closet (e.g., air monitoring system 204), an air monitoring room, an air storage closet (e.g., air storage system 206), an air storage room, the fire command center, the fire command room, a fire alarm panel, a software application 190 (e.g., fire safety application 502) of a computing device 120_{1-N}, a fill station (e.g., internal air fill station 202) of the building 308 and/or a temporarily established fill station connected to a compressed air source (e.g., source of compressed air 170) during the emergency state.

The smart lock 118 associated with the breathable-air supply system 102 may automatically unlock each location 370 of the breathable-air supply system 102 usable during the emergency state 380 of the building 308. The fire-rated evacuation area 350 of the building 308 may be a stairwell. The array of sensors 104_{1-N} may, in some embodiments, be understood as a standalone sensor with one or more capabilities discussed herein.

In another embodiment, a method of a safety system 150 of a building 308 includes facilitating the breathable-air supply system 102 to deliver breathable air from a source of compressed air 170, and supplying breathable air to an emergency personnel 122_{1-N} through a fill station (e.g., internal air fill station 202) in a fire-rated evacuation area 350 (e.g., a stairwell) of the building 308. The method also includes automatically unlocking smart lock 118 associated with the breathable-air supply system 102 usable by the emergency personnel 122_{1-N} during an emergency state 380 of the building 308. The automatic unlocking of the smart lock 118 permits entry to one or more location(s) 370 of the breathable-air supply system 102 to access the breathable air during the emergency state 380 of the building 308. In addition, the method includes integrating an array of sensors 104_{1-N} within the breathable-air supply system 102 to detect the emergency state 380 based on a threshold level (e.g., a first predetermined threshold value, a second predetermined threshold value and so on) of an air quality parameter (e.g., the parameters discussed herein with threshold levels), and configuring the array of sensors 104_{1-N} to trigger an alert signal 192 to automatically unlock the smart lock 118 on detection of the emergency state 380.

The method of the safety system 150 of the building 308 may automatically record an audiovisual incident (e.g., visual recording 142 and/or audio communication 144) using a video camera 174 when the one or more location(s) 370 of the breathable-air supply system 102 is accessed by the emergency personnel 122_{1-N} in an unlock state 154 of the smart lock 118. The method may involve communicating the audiovisual incident to breathable air supply command center 110 (e.g., a remote fire command center, an onsite fire command center) and/or a fire command room through a cloud computing network 106.

The smart lock 118 associated with the breathable-air supply system 102 may be accessed using a Radio Frequency Identification (RFID) system, a smart card, a key fob access, a Non-Fungible Token (NFT), a physical key and/or a web-based identification system. The method may involve generate a trigger signal 194 (e.g., based on array of sensors 104_{1-N}) to alert the emergency personnel 122_{1-N}, breathable air supply command center 110 and/or the fire command room based on a detection (e.g., using array of sensors 104_{1-N}) of tampering of the smart lock 118 associated with the breathable-air supply system 102.

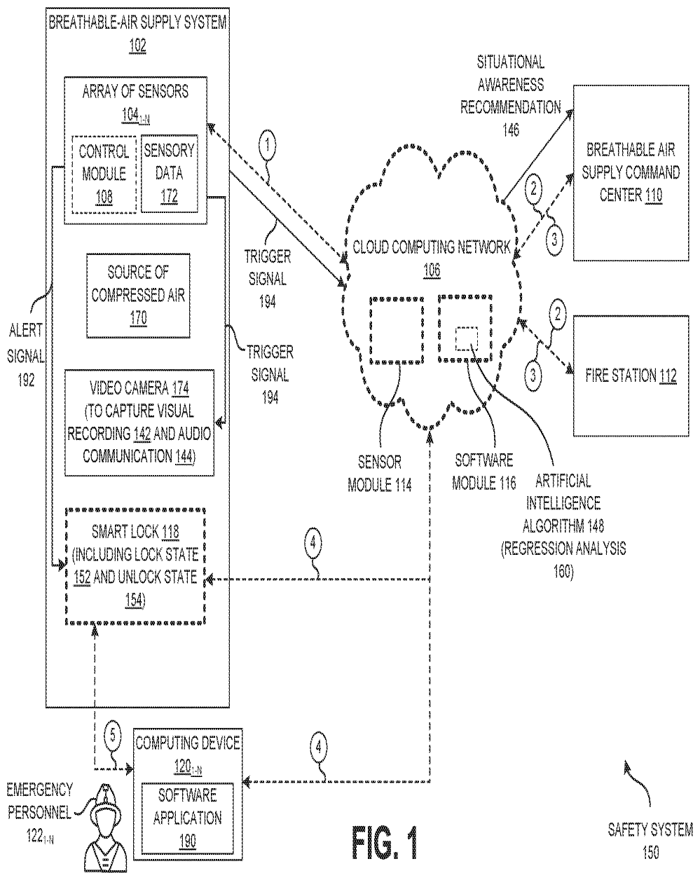

FIG. 1 shows a safety system 150 interpretable as a smart locking system of a breathable-air supply system 102 involving remote operation of a smart lock 118 through a cloud computing network 106 (e.g., of a breathable-air supply command center 110), according to one or more embodiments. The breathable-air supply system 102 may be an interconnected network of components designed to provide for a continuous, unobstructed and reliable source of breathing air to an emergency responder (e.g., a firefighter, emergency personnel 122_{1-N}). The breathable-air supply system 102 may be located in a central part of building 308 (an example occupiable structure) hosting various components thereof. The breathable-air supply system 102 may include a network of air standpipes 302 embedded in a fire-rated channel to supply breathable air.

Different components of the breathable-air supply system 102 may be communicatively coupled to the breathable-air supply command center 110 and the fire station 112 through the cloud-computing network 106 to enable real-time monitoring thereof. The breathable-air supply system 102 may include an array of sensors 104_{1-N} to collect real-time sensory data 172 for continuous monitoring of components thereof. The breathable-air supply system 102 may be installed in a fire-rated room (e.g., chamber) of the building 308. The air standpipes 302 installed within building 308 may be connected to the breathable-air supply system 102 to deliver a safe, instant and constant supply of air replenishment to the emergency responders (e.g., emergency personnel 122_{1-N}, firefighters). The breathable-air supply system 102 may function as a primary command center (e.g., fire control room 222 in an emergency situation) for the specific building 308 in which the particular breathable-air supply system 102 unit is installed, according to one embodiment.

The array of sensors 104_{1-N} may be a collection of sensors (e.g., device, module, machine, and/or subsystem) deployed in a specific geometric pattern for collecting and/or processing electrical, electromagnetic and/or acoustic signals within the breathable-air supply system 102 Other forms of signals are within the scope of the exemplary embodiments discussed herein. The array of sensors 104_{1-N} may also be interpreted as a standalone sensor having one or more capabilities discussed herein in some embodiments. The array of sensors 104_{1-N} may detect events and/or changes in an environment thereof and send the information to various components of the breathable-air supply system 102 through cloud computing network 106. The array of sensors 104_{1-N} may be configured to automatically measure one or more physical inputs from the environment thereof and convert said data into sensory data 172 that can be interpreted by the cloud computing network 106.

The cloud computing network 106 may be a computer network that provides network interconnectivity between cloud-based and/or cloud-enabled applications, services, and/or solutions within the network to monitor and manage the maintenance of air replenishment and/or air quality parameters in the breathable-air supply system 102. The cloud-computing network 106 may store the digital and/or sensory data 172 from the array of sensors 104_{1-N} to analyze the functionalities of the components in the breathable-air supply system 102, according to one embodiment. The control module 108 may be a series of standardized units configured to regulate the array of sensors 104_{1-N} and/or various components in the breathable-air supply system 102 based on sensory data 172 collected by the array of sensors 104_{1-N}, according to one embodiment.

The breathable-air supply command center 110 (e.g., onsite fire command center, remote fire command center, fire control room 222 (example fire command room)) may be a focal point for generation, dispatch and management of monitoring and maintenance of air replenishment in the breathable-air supply system 102 The breathable-air supply command center 110 may optimally manage the resources in the cloud-computing network 106 to detect and/or rectify anomalies (e.g., air contamination, particulates, pollutants, etc.) found in the breathable-air supply system 102 by the array of sensors 104_{1-N}, according to one embodiment.

The fire station 112 may be the designated housing for emergency responders (and emergency personnel 122_{1-N}) and firefighting apparatuses thereof to enable the fastest response possible to breathable-air supply system 102 customers (e.g., fire safety personnel including emergency personnel 122_{1-N}, rescuers, etc.) and emergency personnel 122_{1-N}. The computing device 120_{1-N} may be a digital electronic machine (e.g., a data processing device) communicatively coupled to the cloud computing network 106 that can be programmed to carry out an automatic sequence of arithmetic and/or logical operations (e.g., computation) to enable the emergency personnel 122_{1-N} to monitor and/or recalibrate the components of the breathable-air supply system 102, according to one embodiment. As shown in FIG. 1, computing device 120_{1-N} may execute software application 190 (e.g., fire safety application 502) thereon that may enable access to the one or more location(s) 370.

The sensor module 114 may be a series of standardized units in the cloud computing network 106 that are configured to regulate the array of sensors 104_{1-N} and/or various components in the breathable-air supply system 102 based on sensory data 172 collected by the array of sensors 104_{1-N}. The breathable-air supply command center 110, the breathable-air supply system 102, and/or the emergency personnel 122 may reconfigure the sensor module 114 to regulate the array of sensors 104_{1-N} based on sensory data 172 during the emergency situation (e.g., emergency state 380), according to one embodiment.

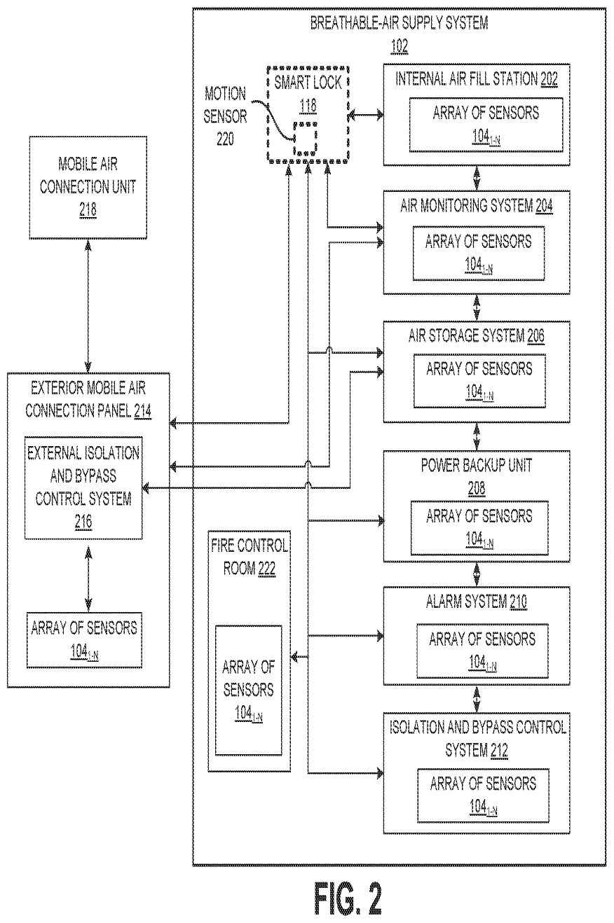

The software module 116 may be a series of instructions and/or a set of rules to be followed in problem-solving operations to automatically detect an error and/or a fault (e.g., increased temperature, variation in pressure, leakage, anomalies in the air quality parameters, etc.) in any of the components (e.g., internal air fill station 202, air monitoring system 204, air storage system 206, etc.) and/or air standpipe 302 of the breathable-air supply system 102 and generate a recommendation to rectify the error and/or fault using artificial intelligence, machine learning methods, and/or other predefined algorithms to optimally modify, maintain, and/or manage the resources of the breathable air-supply system 102 FIG. 2 shows array of sensors 104_{1-N} as part of internal air fill station 202 air monitoring system 204, air storage system 206, a power backup unit 208 (to be discussed below), an alarm system 210 (to be discussed below), isolation and bypass control system 212, and fire control room 222 for example purposes.

The smart lock 118 of the breathable air supply system 102 may be a programmable electromechanical device to automatically secure the various units of the breathable-air supply system 102 from unauthorized access and/or tampering. The smart lock 118 may be integrated with each unit of the breathable-air supply system 102 (e.g., air monitoring system 204, internal air fill station 202 air storage system 206, isolation and bypass control system 212 power backup unit 208, alarm system 210, and an exterior mobile air connection panel 214 (to be discussed below)) to secure the units from unauthorized access, intrusion and/or tampering, according to one embodiment. In one or more embodiments the smart lock 118 may include a securing mechanism configured to automatically lock and/or unlock various units of the breathable-air supply system 102 once an instruction (e.g., triggering instructions from the array of sensors 104_{1-N}) is received thereby from the breathable-air supply command center 110 and/or an authorized user device (e.g., computing device 120_{1-N}).

In another embodiment, the smart lock 118 may be integrated with the array of sensors 104_{1-N} to detect the emergency state 380 (e.g., one or more drops in air quality parameters) of building 308. The smart lock 118 associated with the breathable-air supply system 102 may be programmed to automatically unlock the one or more locations 370 (e.g., each location 370) of the breathable-air supply system 102 usable by the emergency personnel 122_{1-N} to access the breathable air once the emergency state 380 of the building 308 is detected by the array of sensors 104_{1-N}.

In a further embodiment, the authorized device (e.g., computing device 120_{1-N}) may include an RFID system, a wireless protocol, a smart card, key fob access, an NFT, a physical key, biometric access, a web-based identification system, etc. The smart lock 118 may be associated with the one or more locations 370 of the breathable-air supply system 102 (e.g., internal air fill station 202, air monitoring system 204, air storage system 206, power backup unit 208, alarm system 210, isolation and bypass control system 212, exterior mobile air connection panel 214, fire control room 222, etc.) to secure the system from any intrusion therein.

The smart lock 118 may include a tamper switch (not shown; e.g., associated with the array of sensors 104_{1-N}) to automatically trigger an alert signal (e.g., alert signal 192) when the intrusion within the breathable-air supply system 102 occurs. The alert signal 192 may serve as an alarm to the emergency personnel 122_{1-N}, breathable air supply command center 110 (e.g., a remote fire command center, an onsite fire command center) and/or the fire command room (e.g., fire control room 222) indicating that tampering of the smart lock 118 has been detected using the computing device 120_{1-N} (e.g., smart phone, tablet, etc.) and/or array of sensors 104_{1-N} through the software application (e.g., software application 190) implementation.

In another embodiment, the smart lock 118 may be made of metallic material (e.g. 18 gauge carbon steel) to protect the breathable-air supply system 102 from intrusion and/or physical damage. The smart lock 118 may further be made of a weather-resistant and/or ultraviolet solar radiation-resistant and/or infrared solar radiation-resistant material that prevents the smart lock 118 from corrosion and/or deterioration of material due to prolonged exposure to harsh environmental and/or weather conditions. In addition, the smart lock 118 may include video camera 174 to capture a visual recording 142 and/or an audio communication 144 when the breathable-air supply system 102 is accessed by anyone in the unlock state 154, according to one embodiment.

The array of sensors 104_{1-N} may continuously monitor parameters of the breathable-air supply system 102 such as temperature, pressure, air components, air replenishment, availability of air, air leakage, fire detection, airflow, power supply, and/or other breathable air parameters (e.g. oil mist and particulates, odor). The array of sensors 104_{1-N} may be configured to detect the emergency state 380 of building 308 whenever a specific parameter of the breathable-air supply system 102 is above and/or below predefined threshold values (e.g., as discussed above) and/or outside predetermined range(s) of values. During the emergency state 380 of building 308, the array of sensors 104_{1-N} may generate an electrical signal to automatically unlock the smart lock 118 of the one or more location(s) 370 of the breathable-air supply system 102 usable by the emergency personnel 122_{1-N}. The automatic unlocking of the smart lock 118 may permit entry to the one or more location(s) 370 of the breathable-air supply system 102 to access the breathable air during the emergency state 380 of building 308, according to one embodiment. The computing device 120_{1-N} may enable emergency personnel 122_{1-N} to monitor and/or recalibrate components of the breathable-air supply system 102 based on sensory data 172 of the array of sensors 104_{1-N}, according to one embodiment.

The emergency personnel 122_{1-N} may be an entity/entities and/or person(s) authenticated by the breathable-air supply command center 110 to access and/or manage the resources in the breathable-air supply system 102 through the cloud computing network 106. Each emergency personnel 122_{1-N} of the breathable-air supply system 102 may be given a dedicated web interface where a user thereof can monitor breathable-air supply system 102 view historical data, use mobile controls, initiate air tests, and/or obtain printed reports, etc. associated with different units of the breathable-air supply system 102

FIG. 1 illustrates the remote operation of the smart lock 118 through cloud computing network 106 of breathable-air supply command center 110, according to one embodiment. In circle ‘1’, the real-time sensory data 172 of array of sensors 104_{1-N} from each units of the breathable-air supply system 102 (e.g., internal air fill station 202 air monitoring system 204, air storage system 206, power backup unit 208, alarm system 210, isolation and bypass control system 212, exterior mobile air connection panel 214, fire control room 222, etc.) may be communicated to the breathable air supply command center 110 and/or emergency personnel 122_{1-N} through the cloud computing network 106.

In circle ‘2’, the cloud computing network 106 may automatically detect an error and/or fault (e.g., increased temperature, variation in pressure, leakage, anomalies in the air quality parameters, etc.) in any of the components (e.g., internal air fill station 202, air monitoring system 204, air storage system 206, etc.) and/or air standpipes 302 of the breathable-air supply system 102 using the software module 116. In circle ‘3’, the breathable air supply command center 110 and/or the fire station 112 may regulate the array of sensors 104_{1-N} of the breathable-air supply system 102 using the sensor module 114 of the cloud computing network 106. In circle ‘4’, the cloud computing network 106 may automatically generate and send a recommendation to rectify errors/faults using software module 116. In circle ‘5’, the emergency personnel 122_{1-N} may automatically send signals via computing device 120_{1-N} to unlock a particular component or a number of components of the breathable-air supply system 102

FIG. 2 shows breathable-air supply system 102 of FIG. 1 in more detail. The array of sensors 104_{1-N} associated with the smart lock 118 may include a motion sensor 220 in the one or more location(s) 370 (e.g., the air monitoring system 204, internal air fill station 202 air storage system 206, isolation and bypass control system 212 power backup unit 208, the alarm system 210, exterior mobile air connection panel 214) of the breathable-air supply system 102 The motion sensor 220 may be an electronic device that detects a movement and/or presence of nearby emergency personnel 122_{1-N}, people, and/or objects in the one or more location(s) 370 of the breathable-air supply system 102. The motion sensor 220 may generate a trigger signal (e.g., trigger signal 194) to activate the video camera 174 when the breathable-air supply system 102 is being accessed by anyone (e.g., emergency personnel 122_{1-N}, unauthorized persons, etc.) in the unlock state 154.

The motion sensor 220 may further generate a trigger signal (e.g., trigger signal 194) to activate the video camera 174 when tampering with the smart lock 118 is detected. In addition, the motion sensor 220 may activate the video camera 174 when anomalies in the environment associated with the one or more location(s) 370 are detected by the array of sensors 104_{1-N}. The video camera 174 may capture the visual recording 142 and/or audio communication 144 ambient to the one or more location(s) 370. The video camera 174 may further communicate the audiovisual incident (e.g., based on visual recording 142 and/or audio communication 144) to the emergency personnel 122_{1-N}, breathable air supply command center 110 (e.g., an onsite fire command center, a remote fire command center) and/or a fire control room 222 (example fire command room) via computing devices 120_{1-N} (e.g., smart phone, tablet, etc.) through the cloud computing network 106. Further, the breathable-air supply system 102 may automatically transcribe the audio communication 144 and/or the visual recording 142 ambient to the one or more locations 370, according to one embodiment.

The array of sensors 104_{1-N} may detect a normal state 390 of building 308. Normal state 390, as discussed herein, may refer to a state where no compromise of components of breathable-air supply system 102 is detected. The array of sensors 104_{1-N} may generate an electrical signal to automatically lock the smart lock 118 of the breathable-air supply system 102 whenever the emergency state 380 ends and normal state 390 of the building 308 is detected. Lock state 152 and unlock state 154 of the smart lock 118 may be determined based on sensory data 172 of the array of sensors 104_{1-N} within the breathable-air supply system 102. Further, the smart lock 118 may be remotely accessed (e.g., unlocked and/or locked) by the emergency personnel 122_{1-N}, breathable air supply command center 110 (e.g., an onsite fire command center, a remote fire command center) and/or a fire control room 222 via computing devices 120_{1-N} (e.g., smart phone, tablet, etc.) through the implementation of software application 190. Software application 190 may activate the array of sensors 104_{1-N} to generate the electrical signal to lock and/or unlock the smart lock 118 through cloud computing network 106, according to one embodiment.

In another embodiment, the smart lock 118 may include a dual authentication system to unlock the smart lock 118 during the normal state 390 of building 308. One example authentication system may include biometric authentication (e.g., audiovisual identification, fingerprint identification, etc.). Other example authentication systems may include but are not limited to a rapid access system 304 an RFID system, a wireless protocol, a smart card, key fob access, an NFT, a physical key, and/or a web-based identification system.

The smart lock 118 associated with the internal air fill station 202 may secure breathable-air supply system 102 from intrusion and/or tampering. The smart lock 118 may be programmed to automatically unlock the one or more location(s) 370 of internal air fill station 202 usable by emergency personnel 122_{1-N} during the emergency state 380 of building 308. Further, the smart lock 118 may be programmed to automatically lock the one or more location(s) 370 of the internal air fill station 202 accessed by the emergency personnel 122_{1-N} when the emergency state 380 of building 308 ends and the normal state 390 of the building 308 is detected, according to one embodiment. In addition, the internal air fill station 202 may include an air fill charge rate controller, an emergency status indicator, an actuator control valve, a Self-Contained Breathing Apparatus (SCBA) connector unit, a radio repeater, the array of sensors 104_{1-N}, and smart lock 118, according to one embodiment.

The air monitoring system 204 may be a collection of elements and/or components that are organized for checking and/or recording the air quality within breathable-air supply system 102. The air monitoring system 204 may include an air quality display unit, an air quality analysis unit, a compressor, array of sensor units 104_{1-N}, and smart lock 118 according to one embodiment. The smart lock 118 may be associated with the air monitoring system 204 to secure breathable-air supply system 102 from intrusion and/or tampering. The smart lock 118 may be programmed to automatically unlock the one or more location(s) 370 of the air monitoring system 204 usable by the emergency personnel 122_{1-N} during emergency state 380 of the building 308. In addition, the smart lock 118 may be programmed to automatically lock the one or more location(s) 370 of the air monitoring system 204 usable by the emergency personnel 122_{1-N} on detection of normal state 390 of the building 308, according to one embodiment.

The air quality display unit (not shown) may exhibit the air parameters captured and analyzed by the air quality analysis unit (not shown) of the air monitoring system 204 in real-time. The air quality display unit may be a smart device (e.g., an Android™ based computing device, an iOS® based computing device such as an electronic tablet, electronic notebook, etc.) having a mini touchscreen for visual presentation of the quality of air parameters analyzed by the air analysis unit based on sensory data 172 of the array of sensors 104_{1-N}, according to one embodiment.

In another embodiment, the air quality display unit may be an electromechanical device installed at the key locations 370 of building 308 and may be made of a material having fire-rated capabilities. The air quality display unit may communicate through wired and/or wireless means to external devices including computing systems (e.g., computing device 120_{1-N}). The array of sensors 104_{1-N} may be configured to automatically trigger recording of the visual incidents discussed above using a camera (e.g., video camera 174) installed on the air quality display unit communicatively coupled to the computing device 120_{1-N} (e.g., smart device, iPad®, tablet, etc.) to provide visual incidents at the fire ground. The air quality display unit may help to monitor the air quality status in the breathable-air supply system 102 remotely in real-time via mobile devices and/or a breathable air supply command center 110 and/or other key locations 370 of the breathable-air supply system 102 and/or building 308.

The air quality analysis unit may be a sensor-based device to automatically detect air quality, moisture and/or pressure in the breathable-air supply system 102. The air quality analysis unit may include air quality sensors 414 (e.g., part of array of sensors 104_{1-N}) for continuous monitoring (e.g., 365 days/year) of the breathable-air components. The breathable-air components may include carbon monoxide, carbon dioxide, nitrogen, oxygen, moisture, pressure, hydrocarbon levels, and other breathable air parameters (e.g., oil mist and particulates, odor, etc.). The air quality sensors 414 may include a carbon monoxide sensor 416, a carbon dioxide sensor 418, a nitrogen level sensor 422 an oxygen level sensor 420, a moisture sensor 426, a pressure sensor 428, a hydrocarbon sensor 424, and/or other sensors (e.g. oil mist and particulates sensor, odor sensor, etc.). The air quality display unit may display air quality analysis unit data (e.g., the breathable-air components, parameters, etc.), according to one embodiment.

The air quality analysis unit may use a digital processor unit 430 to check deviation in the air quality parameters in the breathable-air supply system 102. The air quality analysis unit may generate an alert signal (e.g., alert signal 192) if the air-quality parameters are above and/or below predefined threshold levels discussed above. The alert signal 192 may notify emergency personnel 122_{1-N}, breathable air supply command center 110 (e.g., an onsite fire command center, a remote fire command center) and/or a fire control room 222 via computing devices 120_{1-N} (e.g., smart phone, tablet, etc.) through the cloud computing network 106 that the emergency state 380 is detected within the building 308. During emergency state 380, the array of sensors 104_{1-N} may generate electrical signals to automatically unlock the smart lock 118 at the one or more location(s) 370 of the breathable-air supply system 102 usable by the emergency personnel 122_{1-N}.

In an additional embodiment, the air quality analysis unit of the air monitoring system 204 discussed above may be integrated with cloud computing network 106. The breathable-air supply command center 110 of safety system 150 may be communicatively coupled to the breathable-air supply system 102 and the computing device 120_{1-N}/emergency personnel 122_{1-N} through the cloud-computing network 106 The air quality analysis unit may continuously send sensory data 172 of the array of sensors 104_{1-N} of the breathable-air supply system 102 to the breathable-air supply command center 110, fire station 112 and/or emergency personnel 122_{1-N} through a cloud computing network 106. The cloud computing network 106 may enable the breathable-air supply command center 110 and emergency personnel 122_{1-N} to remotely manage and/or continuously monitor (e.g., full vigilance 365 days/year) the air-quality parameters in the breathable-air supply system 102 in real-time via computing device 120_{1-N} through implementation via software application 190, according to one embodiment.

As discussed above, the cloud computing network 106 may use sensor module 114 and software module 116 to check deviations in the air-quality parameters in the breathable-air supply system 102 The cloud computing network 106 may generate an alert signal 192 if the air-quality parameters are above and/or below predefined threshold values discussed above. The alert signal 192 may notify the emergency personnel 122_{1-N}, breathable air-supply command center 110 (e.g., an onsite fire command center, a remote fire command center) and/or a fire control room 222 (example fire command room) via computing device 120_{1-N} (e.g., smart phone, tablet, etc.) that the emergency state 380 is detected. During emergency state 380, the array of sensors 104_{1-N} may be configured to generate electrical signals to automatically unlock the smart lock 118 of the one or more location(s) 370 of the breathable-air supply system 102 usable by the emergency personnel 122_{1-N}, according to one embodiment.

In one implementation, air monitoring system 204 may include a compressor (not shown); said compressor may be a mechanical device that increases the pressure of a gas in the breathable-air supply system 102. The compressor may be integrated into the air quality analysis unit of the air monitoring system 204 discussed above. The compressor may increase the air pressure in the breathable-air supply system 102 when a deviation in air-quality parameters is detected by the air quality sensors 414 to enable automated purging of air in the breathable-air supply system 102 according to one embodiment.

An air quality sensor 414 may activate a control valve to automatically purge the breathable-air supply system 102 upon detection of a deviation in the air-quality parameters above and/or below predefined threshold values (and/or ranges). The automatic purging may be done to purge a certain amount of air out of breathable-air supply system 102, while the air quality analysis unit may continue monitoring the air-quality parameters. After purging, if the air-quality parameters are less/more than the predefined threshold values (and/or ranges), then the array of sensors 104_{1-N} may generate an alert signal 192 that the emergency state 380 is detected. The array of sensors 104_{1-N} may notify the emergency personnel 122_{1-N}, breathable air supply command center 110 (e.g., a remote fire command center, an onsite fire command center) and/or a fire command room (e.g., fire control room 222) via computing devices 120_{1-N} (e.g., smart phone, tablet, etc.) through the cloud computing network 106 that a fault has occurred in the particular unit of the breathable-air supply system 102 that needs immediate attention/correction, according to one embodiment.

An air fill charge rate controller (not shown) may be a hardware device that regulates the flow of breathable air in internal air fill station 202 based on sensory data 172 of the array of sensors 104_{1-N}. The air fill charge rate controller may automatically regulate the maximum allowable pressure in SCBA cylinders while replenishing air through internal air fill station 202 and control the charge rate of the air filling to avoid hot fills in the SCBA cylinders. The array of sensors 104_{1-N} may include an air flow sensor 404 to automatically measure and/or regulate the flow rate of air within the internal air fill station 202. The airflow sensor 404 may utilize mechanical and/or electrical means to measure changes in the physical attributes of the air within safety system 150 and calculate flow thereof. The air flow sensor 404 may continuously monitor the air flow rate within the internal air fill station 202. The airflow sensor 404 may generate the alert signal 192 during a catastrophic event (e.g. malfunctioning of equipment, other anomalies in the air parameters, an event associated with emergency state 380 etc.) and/or if the charge rate of the air flow is not within a predefined threshold limit (e.g., high air flow beyond the pre-described quantity of an SCBA maximum flow). The alert signal 192 may notify emergency personnel 122_{1-N}, breathable air supply command center 110 (e.g., an onsite fire command center, a remote fire command center) and/or a fire control room 222 (example fire command room) via computing devices 120_{1-N} (e.g., smart phone, tablet, etc.) that the emergency state 380 is detected through cloud computing network 106, according to one embodiment.

In one embodiment, the array of sensors 104_{1-N} may automatically unlock the smart lock 118 of internal air fill station 202 in which the emergency state 380 is detected. In another embodiment, the air flow sensor 404 may generate an electrical signal to automatically activate actuator valves (not shown) to shut down and/or isolate internal air fill station 202 when the emergency state 380 is detected.

According to one embodiment, internal air fill station 202 may include an emergency status indicator (not shown). The array of sensors 104_{1-N} (e.g., smoke sensor 406, etc.) associated with internal fill station 202 may be configured to detect a low and/or a poor visibility state (example emergency state 380) within building 308. In other words, the array of sensors 104_{1-N} may detect an emergency state 380 of building 308 during low and/or poor visibility conditions. During the emergency state 380, the array of sensors 104_{1-N} may generate an electrical signal to automatically unlock the smart lock 118 of the one or more location(s) 370 of the breathable-air supply system 102 usable by the emergency personnel 122_{1-N}. The array of sensors 104_{1-N} may further generate the electrical signal to activate the emergency status indicator when the emergency state 380 of building 308 is detected. The emergency status indicator may be a signal unit that helps the emergency personnel 122_{1-N} identify internal air fill station 202 in critical situations (e.g., low or poor visibility during fire and/or smoke, etc.).

According to one embodiment, the emergency status indicator may include indication systems associated with internal air fill station 202 serving as status indicators. These indication systems may facilitate the emergency responders, emergency personnel 122_{1-N} and/or firefighters in locating internal air fill station 202 under low visibility conditions via blue light, strobe light, and/or white light, etc.

In another embodiment, the emergency status indicator associated with internal air fill station 202 may include a thermal imaging marker (TIC) (not shown) and/or glow locators (not shown). The TIC and/or the glow locators may be integrated with internal air fill station 202 and may include thermal imaging cameras for quick decision-making on the part of the firefighters, emergency personnel 122_{1-N} and/or emergency responders and serving as indicators of the directions to move along in limited visibility conditions.

The actuator control valve(s) associated with internal air fill station 202 may be a hardware and/or software control mechanism that automatically open and close to control the flow of air in internal air fill station 202 and/or other components of breathable-air supply system 102 remotely during the emergency state 380 of the building 308, according to one embodiment. The actuator control valve(s) may be remotely controlled by isolation and bypass control system 212. In addition, the actuator control valve(s) may be controlled by breathable-air supply command center 110 (e.g., an onsite fire command center, a remote fire command center) and/or a fire control room 222 (example fire command room) and/or emergency personnel 122_{1-N} via computing device 120_{1-N} through the cloud computing network 106. Based on sensory data 172 of the array of sensors 104_{1-N}, the actuator control valve(s) may be able to automatically isolate and/or bypass internal air fill station 202 in which a fault has occurred, according to one embodiment.

An SCBA connector unit (not shown) may be a device and/or means for securing an SCBA cylinder hose to internal air fill station 202 to allow breathable air to flow from internal air fill station 202 to an SCBA cylinder for replenishment thereof and to allow easy disconnection after the replenishment, according to one embodiment.

According to one embodiment, internal air fill station 202 may include a radio repeater. The radio repeater may be integrated with and/or be within internal air fill station 202 to increase an area of coverage and robustness of communication between firefighters, emergency personnel 122_{1-N} and/or emergency responders and breathable air supply command center 110. The radio repeater may repeat a radio signal received at a first frequency during transmission thereof at a second frequency. The radio repeater may be located at a place where a virtual Line-of-Sight (LoS) to all radios in safety system 150 is possible, according to one embodiment.

The breathable-air supply system 102 may further include air storage system 206. Air storage system 206 may be an assembly of equipment organized for stocking and/or managing the breathable air in the breathable-air supply system 102 for replenishing the SCBA cylinders. Air storage system 206 may further include storage tanks (not shown), a calibration system (not shown), a primary storage tank (not shown), a booster pump (not shown), an array of sensors 104_{1-N}, and smart lock 118. The smart lock 118 associated with air storage system 206 may secure breathable-air supply system 102 from intrusion and/or unauthorized access. The smart lock 118 may be programmed to automatically unlock one or more locations 370 of air storage system 206 usable by the emergency personnel 122_{1-N} during emergency state 380 of building 308, according to one embodiment.

A storage tank may be a breathable air repository where the breathable air is stocked for replenishing the SCBA cylinders. The air stored in the storage tank may be supplied to internal air fill station 202 through a primary storage tank to refill the SCBA cylinders. The primary storage tank may be a set of breathable air storage tanks that is used to supply breathable air to internal air fill station 202 of the breathable-air supply system 102 to enable refilling one or more SCBA cylinders. The booster pump may be configured between the storage tanks and the primary storage tank from which air is drawn to internal air fill station 202. The booster pump may help transfer air from the storage tanks to the primary storage tank when required. The booster pump may also help refill the SCBA cylinders within and/or less than 2 minutes once connected to internal air fill station 202. The booster pump may be calibrated by using the calibration system to maintain an optimum level of pressure in the primary storage tank to supply breathable air to internal air fill station 202 The calibration system may have an actuator valve to bypass air storage system 206 once a mobile air connection unit 218 is connected to breathable-air supply unit 102, according to one embodiment.

The array of sensors 104_{1-N} (e.g., pressure sensors) associated with air storage system 206 may continuously monitor the air pressure in the primary storage tank. If the air pressure in the primary storage tank is less and/or more than the optimal level of pressure (e.g., 6000 pounds per square inch (PSI)), the array of sensors 104_{1-N} may automatically activate the booster pump. The booster pump may be configured to maintain the air pressure in the primary storage tank at an optimal level of pressure (e.g., 6000 PSI) to enable airflow to internal air fill station 202. If the air pressure of the primary storage tank goes beyond and/or below predefined limits, the booster pump may transfer air between the storage tanks and the primary storage tank to maintain the air pressure of the primary storage tank within the predefined limits, according to one embodiment. Low-pressure air may drive pistons within the booster pump to enable maximization of air within the storage tanks, according to one embodiment. In another embodiment, the array of sensors 104_{1-N} may automatically activate the actuator valve within the calibration system to bypass air storage system 206 once mobile air connection unit 218 is connected to the breathable-air supply unit 102

In another embodiment, if the booster pump fails to maintain the air pressure of the primary storage tank at the optimal level of pressure (e.g. 6000 PSI), the array of sensors 104_{1-N} may generate an alert signal 192 to notify the emergency personnel 122_{1-N}, breathable air supply command center 110 (e.g., a remote fire command center, an onsite fire command center) and/or a fire control room 222 (example fire command room) via computing devices 120_{1-N} (e.g., smart phone, tablet, etc.) that the emergency state 380 is detected within breathable-air supply unit 102 During the emergency state 380, the array of sensors 104_{1-N} may generate electrical signals to automatically unlock the smart lock 118 associated with air storage system 206 (e.g., the calibration system, booster pump, etc.) usable by the emergency personnel 122_{1-N}.

In yet another embodiment, the calibration system may use an array of sensors 104_{1-N} to recalibrate the booster pump to maintain the optimum level of pressure in the primary storage tank during the emergency state 380. Further, the actuator valve within the calibration system may be remotely operated by emergency personnel 122_{1-N}, breathable air supply command center 110 (e.g., a remote fire command center, an onsite fire command center) and/or a fire control room 222 (example fire command room) via computing devices 120_{1-N} (e.g., smart phone, tablet, etc.) by using the array of sensors 104_{1-N} within breathable-air supply system 102 through cloud computing network 106.

In yet another embodiment, isolation and bypass control system 212 may be a set of components working together to automatically switch ON/OFF and/or bypass internal air fill station 202 when a fault and/or error is detected within and/or adjacent to a particular internal air fill station 202. Isolation and bypass control system 212 may include an addressable motherboard and circuitry associated therewith, smart lock 118, and array of sensors 104_{1-N}. Isolation and bypass control system 212 may be associated with smart lock 118 to secure breathable-air supply system 102 from intrusion and/or tampering. Smart lock 118 may be programmed to automatically unlock one or more location(s) 370 of isolation and bypass control system 212 usable by the emergency personnel 122_{1-N} during emergency state 380 of the building 308.

The array of sensors 104_{1-N} associated with isolation and bypass control system 212 may continuously monitor air-quality parameters in breathable-air supply system 102. The array of sensors 104_{1-N} associated with isolation and bypass control system 212 may be programmed to activate the actuator control valves to automatically bypass and/or isolate a particular air fill panel (e.g., internal air fill station 202) on the detection of deviation of air-quality parameters from the predefined threshold values (and ranges) discussed above based on sensory data 172 of the array of sensors 104_{1-N}. Actuator control valves provided with each fill panel (e.g., internal air fill station 202) in a floor of building 308 may be turned ON/OFF such that a combination of the fill panels may be isolated as per requirements, according to one embodiment.

In another embodiment, power backup unit 208 may be a device and/or a system to provide instantaneous, uninterruptible power to components of breathable-air supply system 102 during the emergency state 380 of building 308. Power backup unit 208 may be associated with a smart lock 118 to secure breathable-air supply system 102 from intrusion. Smart lock 118 may be programmed to automatically unlock one or more location(s) 370 (e.g., each location 370) of power backup unit 208 usable by emergency personnel 122_{1-N} during an emergency state 380 of building 308. The array of sensors 104_{1-N} (e.g., power sensor 412, etc.) associated with power backup unit 208 may continuously monitor the power supply within the breathable-air supply system 102 The array of sensors 104_{1-N} may activate power backup unit 208 if any anomalies in the power supply are detected (e.g., deviation in current, voltage, power and/or power quality parameters of breathable-air supply system 102 etc.).

In another embodiment, an alarm system 210 may be a device to transmit and/or broadcast an alert signal 192 when emergency state 380 of building 308 is detected. Alarm system 210 may be associated with a smart lock 118 to secure breathable-air supply system 102 (or, alarm system 210) from intrusion and/or tampering. Smart lock 118 may be programmed to automatically unlock one or more location(s) 370 (e.g., each location 370) of alarm system 210 usable by emergency personnel 122_{1-N} during emergency state 380 of building 308. The array of sensors 104_{1-N} associated with breathable-air supply system 102 may generate an alert signal 192 if anomalies (e.g., increased temperature, variation in pressure, leakage, anomalies in the air-quality parameters, availability of air, etc.) in any of the components of the breathable-air supply system 102 are detected thereby. Alert signal 192 may activate alarm system 210 to enable alarm system 210 to notify emergency personnel 122_{1-N}, breathable air supply command center 110 (e.g., a remote fire command center, an onsite fire command center) and/or a fire control room 222 (example fire command room) via computing devices 120_{1-N} (e.g., smart phone, tablet, etc.) through cloud computing network 106 that emergency state 380 of building 308 is detected, according to one embodiment.

In yet another embodiment, mobile air connection unit 218 may be a vehicle (e.g., a fire truck) equipped with a breathable air replenishment system to readily supply the breathable air to the breathable-air supply system 102 in case of an emergency. Exterior mobile air connection panel 214 may be a console provided at a periphery of building 308 to readily access and supply the breathable air to components of breathable-air supply system 102 Exterior mobile air connection panel 214 may include an external isolation and bypass control system 216, an array of sensors 104_{1-N}, and a smart lock 118. Exterior mobile air connection panel 214 may be associated with smart lock 118 to secure breathable-air supply system 102 (or, exterior mobile air connection panel 214) from intrusion and/or tampering. Smart lock 118 may be programmed to automatically unlock exterior mobile air connection panel 214 usable by the emergency personnel 122_{1-N} during emergency state 380 of building 308. External isolation and bypass control system 216 may be a set of components working together to isolate and/or bypass air storage system 206 to enable air supply from mobile air connection unit 218 through exterior mobile air connection panel 214.

In another embodiment, external isolation and bypass control system 216 may isolate and/or bypass air storage system 206 when the array of sensors 104_{1-N} detects emergency state 380. External isolation and bypass control system 216 may use the array of sensors 104_{1-N} to isolate and/or bypass air storage system 206.

In another embodiment, fire control room 222 (example fire command room) may enable emergency personnel 122_{1-N} to manage and/or continuously monitor components of breathable-air supply system 102 in real-time. Fire control room 222 may be associated with a smart lock 118 to secure breathable-air supply system 102 (or, fire control room 222) from intrusion. Smart lock 118 may be programmed to automatically unlock fire control room 222 usable by emergency personnel 122_{1-N} during emergency state 380 of building 308 Sensory data 172 from the array of sensors 104_{1-N} may be collected in fire control room 222 Fire control room 222 may function as a primary command center for building 308 in which a particular breathable-air supply system 102 is installed, according to one embodiment. Further, fire control room 222 may authenticate emergency personnel 122_{1-N} to access various components of the breathable-air supply system

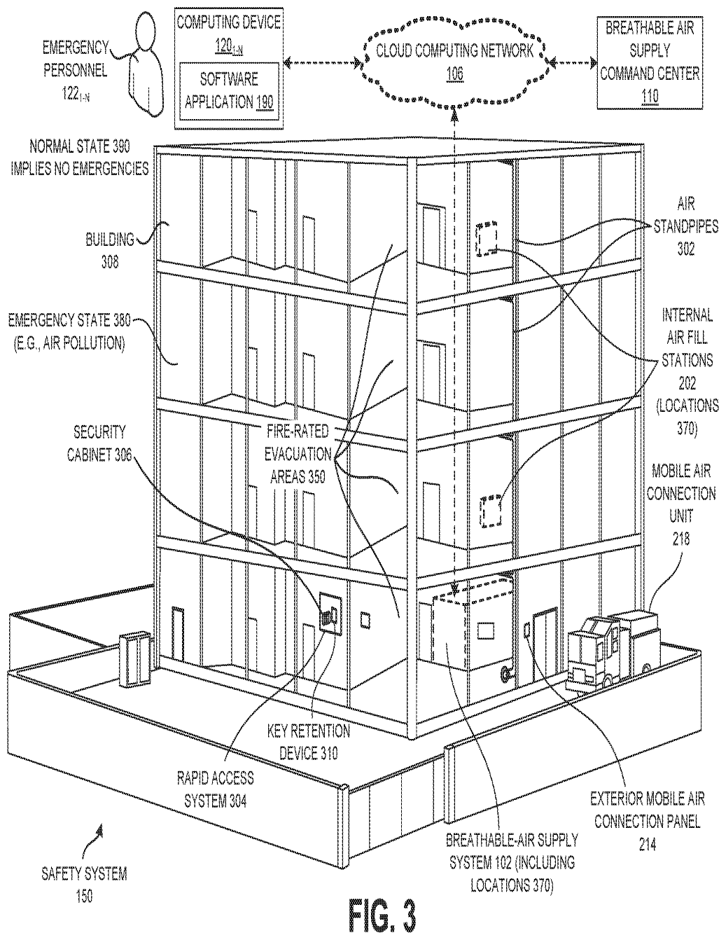

FIG. 3 is a schematic and perspective view of safety system 150 associated with building 308, according to one or more embodiments. Air standpipes 302 may include a fire-rated tubing and/or hose provided at building 308 to supply breathable air to internal air fill station(s) 202 located on different floors of building 308. For example, internal air fill station 202 may be located in a fire-rated evacuation area 350 (e.g., a fire-rated stairwell) of building 308 (e.g., a high-rise building, a medium-rise building, a low-rise building, a multistory building, a skyscraper, a warehouse, a shopping mall, a hypermart, an industrial structure, etc.), according to one embodiment.

Building 308 may be extended to an occupiable structure such as a mid and/or a high-rise building, a large horizontal structure such as a big box retail store, a warehouse and/or a manufacturing plant, a tunnel, a wind turbine, a large marine vessel and a mine shaft. Other variations therein are within the scope of the exemplary embodiments discussed herein.

Breathable-air supply system 102 may be integrated with a rapid access system 304. Rapid access system 304 may be an electronic lock and/or a mechanical lock that provides a quick and simple way to lock and/or unlock smart lock 118 through RFID access, smart cards, key fob access, NFTs, keys, biometric access and/or web-based identification systems.

Breathable-air supply command center 110 may remotely generate an authorized key for emergency personnel 122_{1-N} through cloud computing network 106 to access and automatically adjust components of the breathable-air supply system 102. The authorized key may be activated for a particular duration of time. The authorized key may be sent to computing devices 120_{1-N} (e.g., a smart device, a mobile device, an iPad®, a laptop, a computer) along with the triggering notifications (e.g., security notifications via key fobs, RFID, smart cards), according to one embodiment.

In addition, along with the mobile, wireless and key fob access control, breathable-air supply system 102 may include rapid access system 304 discussed above. Rapid access system 304 may include a key retention device 310, a security cabinet 306 and a master key (not shown). Key retention device 310 may be integrated with cloud computing network 106 Key retention device 310 may also be communicatively coupled with breathable-air supply command center 110 Rapid access system 304 may include an automatic sensor that may send a trigger signal 194 to breathable-air supply command center 110 whenever someone tries to access key retention device 310, according to one embodiment.

Breathable-air supply command center 110 may generate an access personal identification number (PIN) and send the access PIN to computing device 120_{1-N} of emergency personnel 122_{1-N}. Key retention device 310 may retain the master key and only release the master key to emergency personnel 122_{1-N} with authorized PIN codes sent to computing devices 120_{1-N} thereof. Cloud computing network 106 may have a retrievable audit trail unit (not shown) that may record the date and time when the master key is taken and when the master key is returned by emergency personnel 122_{1-N}. The retrievable audit trail unit may also record the identification of emergency personnel 122_{1-N} associated with the taking and the return of the master key. The retrievable audit trail unit may further generate comprehensive audit trail reports for future assessments. Security cabinet 306 of rapid access system 304 may house both the master key and other mechanical keys and may provide temporary access to emergency responders, emergency personnel 122_{1-N} and/or firefighters through the master key, according to one embodiment.

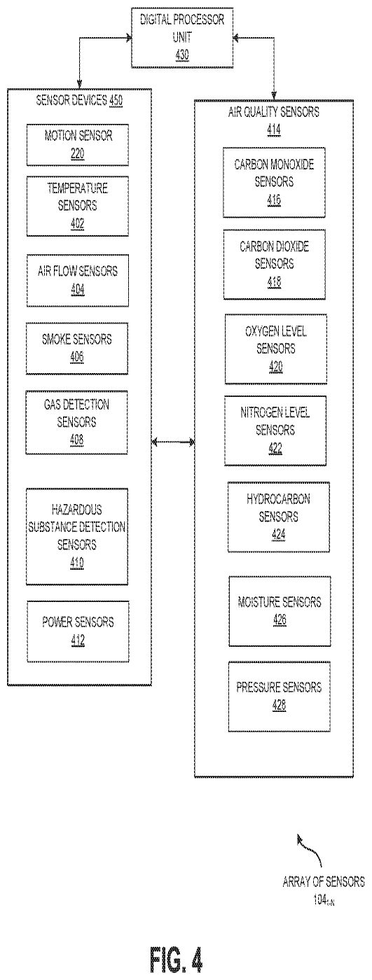

FIG. 4 shows array of sensors 104_{1-N} of breathable-air supply system 102, according to one embodiment. The array of sensors 104_{1-N} may include air quality sensors 414, sensor devices 450, and a digital processor unit 430. The array of sensors 104_{1-N} may be configured to detect emergency state 380 of building 308 whenever a certain parameter (e.g., air-quality parameter) of breathable-air supply system 102 is above and/or below the predefined threshold values (and/or ranges) discussed above. During emergency state 380 of building 308, the array of sensors 104_{1-N} may generate an electrical signal to automatically unlock smart lock 118 of one or more location(s) 370 (e.g., each location 370) of the breathable-air supply system 102 usable by the emergency personnel 122_{1-N}, according to one embodiment.

Air quality sensors 414 may include a collection of sensors including but not limited to carbon monoxide sensors 416, carbon dioxide sensors 418, oxygen level sensors 420, nitrogen level sensors 422, hydrocarbon sensors 424, moisture sensors 426, pressure sensors 428 and other air-quality parameter measuring sensors (e.g., oil mist and particulates sensor, odor sensor, etc.). Carbon monoxide sensor 416 may trigger emergency state 380 of building 308 when a level of ambient carbon monoxide exceeds a first threshold predetermined value (e.g., 5 ppm, 10 ppm). Carbon dioxide sensor 418 may trigger emergency state 380 of the building when a level of ambient carbon dioxide exceeds a second predetermined threshold value (e.g., 1000 ppm, 1200 ppm). Oxygen level sensor 420 may trigger emergency state 380 of building 308 when a level of ambient oxygen falls outside a predetermined range of values (e.g., between 19.5% and 23.5%). Nitrogen level sensor 422 may trigger emergency state 380 of building 308 when a level of nitrogen falls below a third predetermined threshold value (e.g., 75%). Further, nitrogen level sensor 422 may also trigger emergency state 380 of building 308 when a level of nitrogen rises above a fourth predetermined threshold value (e.g., 81%), according to one embodiment.

In another embodiment, hydrocarbon sensor 424 may trigger emergency state 380 of building 308 when a condensed hydrocarbon content exceeds a fifth predetermined threshold value (e.g., 5 milligrams per cubic meter of air). Moisture sensor 426 may trigger emergency state 380 of building 308 when a moisture concentration exceeds a sixth predetermined threshold value (e.g., 24 ppm by volume). Pressure sensor 428 may trigger emergency state 380 of building 308 when pressure falls below a seventh predetermined threshold value (e.g., 90 percent of the maintenance pressure specified in a fire code). In another embodiment, pressure sensor 428 may further be used to detect the pressure in the primary storage tank discussed above. Here, pressure sensor 428 may trigger emergency state 380 of building 308 when the booster pump discussed above fails to maintain the optimal level of pressure (e.g., 6000 PSI) in the primary storage tank.

The sensor device 450 may include a collection of sensors such as a motion sensor 220, temperature sensors 402, air flow sensors 404, smoke sensors 406, gas detection sensors 408, hazardous substance detection sensors 410, power sensors 412 and/or other anomaly measuring sensors (e.g. environmental condition measuring sensors, malfunctioning of equipment detection sensors, etc.). Motion sensor 220, as discussed above, may be an electronic device that detects the movement and/or presence of nearby emergency personnel 122_{1-N} and/or people and/or objects in the one or more location(s) 370 (e.g., access locations) of breathable-air supply system 102 Motion sensor 220 may further detect unlock state 154 of smart lock 118 Motion sensor 220 may generate a trigger signal 194 to activate video camera 174 when breathable-air supply system 102 is accessed by anyone (e.g., emergency personnel 122_{1-N}, unauthorized persons, etc.) in unlock state 154. Motion sensor 220 may also generate emergency state 380 of building 308 when tampering with smart lock 118 is detected. In addition, motion sensor 220 may activate video camera 174 when anomalies in environmental conditions associated with the one or more location(s) 370 are detected, according to one embodiment.

Temperature sensor 402 is a device that may be used to measure the temperatures of different components (e.g. air, liquid, and/or solid matter, etc.) within breathable-air supply system 102 Temperature sensor 402 may further measure the temperatures of different equipment within the breathable-air supply system 102. Also, temperature sensor 402 may continuously monitor the temperatures of breathable-air supply system 102. Temperature sensor 402 may trigger emergency state 380 of building 308 when a temperature within breathable-air supply system 102 is above and/or below predefined thresholds. In addition, temperature sensor 402 may be used to measure an environmental temperature within breathable-air supply system 102 Temperature sensor 402 may trigger emergency state 380 of building 308 when the environment temperature of building 308 is above and/or below predefined thresholds, according to one embodiment.

Air flow sensors 404 may automatically measure and/or regulate the flow rate of air within breathable-air supply system 102. Air flow sensor 404 may utilize both mechanical and electrical means to measure changes in physical attributes of the air within breathable-air supply system 102 and calculate flow thereof. Air flow sensor 404 may continuously monitor the air flow rate within the breathable-air supply system 102. Air flow sensor 404 may trigger emergency state 380 of building 308 during a catastrophic event (e.g. malfunctioning of equipment, other anomalies in the air-quality parameters, etc.) and/or if a charge rate of the air flow is not within predefined threshold limits (e.g., high air flow beyond a pre-described quantity of an SCBA maximum flow).

Smoke sensor 406 maybe a device that detects fires and/or smoke by sensing small particles in the air. Smoke sensor 406 may trigger emergency state 380 of building 308 when the fires and/or smoke particles are above certain threshold values. In addition, smoke sensor 406 may activate the emergency status indicator discussed above that helps emergency personnel 122_{1-N} identify internal air fill station 202 in critical situations (e.g., low or poor visibility during the fire and/or smoke, etc.). Gas detection sensor 408 may be a device that detects air leakage within breathable-air supply system 102. Gas detection sensor 408 may detect emergency state 380 of building 308 when air leakage within breathable-air supply system 102 is detected. Hazardous substance detection sensor 410 may detect and/or measure the presence of specific toxic gases within breathable-air supply system 102. Hazardous substance detection sensor 410 may trigger emergency state 380 of building 308 when specific toxic gases within breathable-air supply system 102 are detected, according to one embodiment.

Power sensor 412 may be used to measure the electrical power parameters (e.g., voltage, current, power and other power quality parameters, etc.) of breathable-air supply system 102 Power sensor 412 may trigger emergency state 380 of building 308 when a deviation in the electrical power parameters is above and/or below predefined threshold limits (e.g., as per IEEE standards), according to one embodiment.

Digital processor unit 430 may take real-time sensory data 172 of the array of sensors 104_{1-N} and use statistical analysis and/or artificial intelligence algorithm(s) to check deviation in the breathable-air/air-quality parameters (e.g., temperature, pressure, air components, air replenishment, availability of air, air leakage, fire detection, air flow, power supply, oil mist and particulates, odor, etc.) in breathable-air supply system 102 In one or more embodiments, digital processor unit 430 may be associated with a processor (e.g., a microprocessor, a microcontroller) to perform all functionalities and execute operations thereof associated with the array of sensors 104_{1-N}.

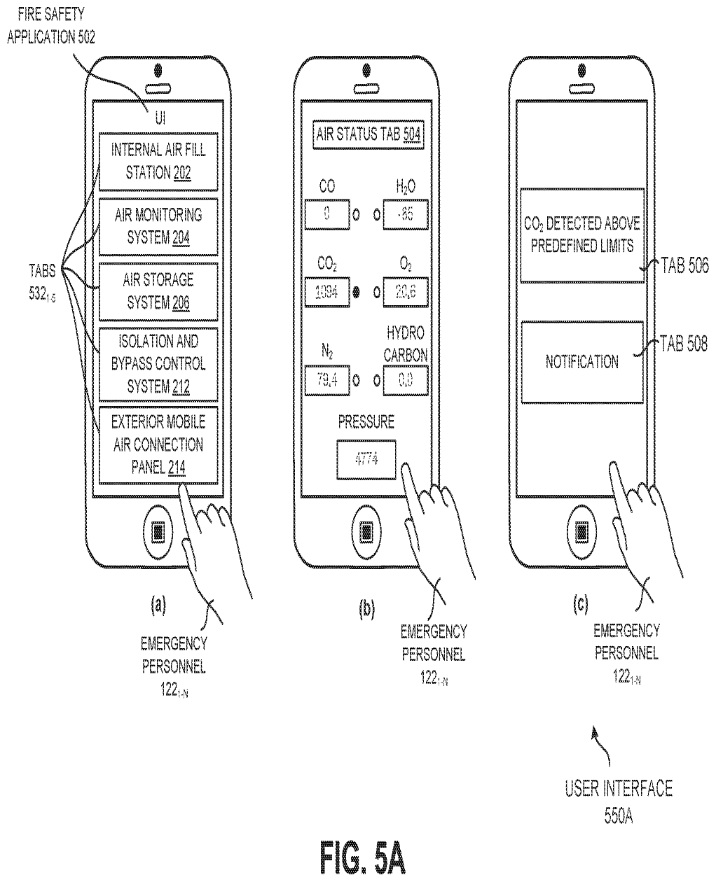

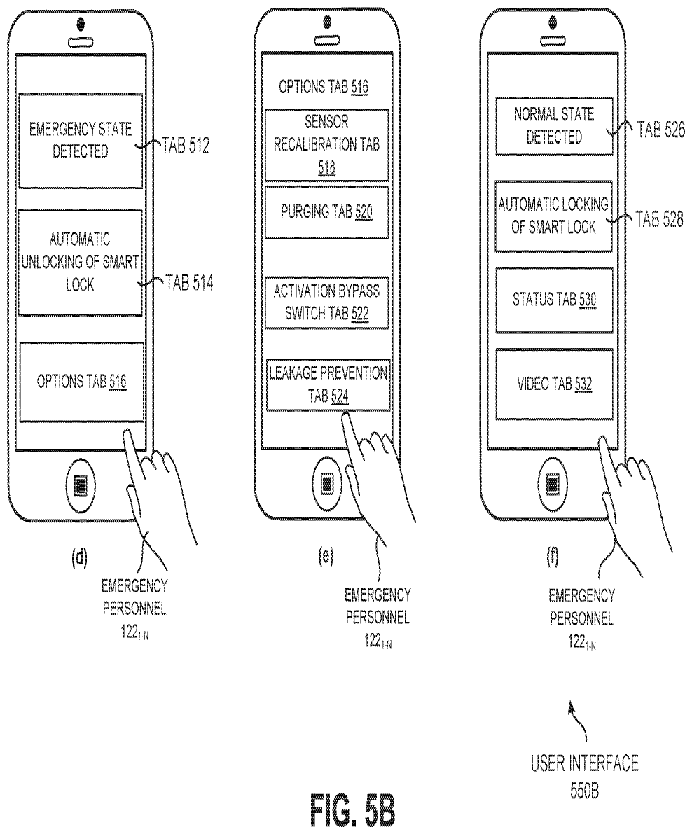

FIG. 5A shows a user interface 550A of a fire safety application 502 (an example software application 190 executing on computing device 120_{1-N}), according to one embodiment. Particularly, FIG. 5A illustrates fire safety application 502 of cloud computing network 106 execution on computing device 120_{1-N} that displays parameters detected by the array of sensors 104_{1-N} of breathable-air supply system 102, according to one embodiment. As shown in ‘(a)’, user interface 550A of breathable-air supply system 102 may help emergency personnel 122_{1-N} to view and monitor the different working parameters of units of breathable-air supply system 102 (e.g., internal air fill station 202, air monitoring system 204, air storage system 206, isolation and bypass control system 212 exterior mobile air connection panel 214). Emergency personnel 122_{1-N} may click on multiple tabs (e.g., tabs 532₁₋₅) to view different air/air-quality parameters of breathable-air supply system 102 As shown in ‘(b)’, an air status tab 504 may display various air/air-quality parameters of breathable-air supply system 102, according to one embodiment.

For example, emergency personnel 122_{1-N} may view the different air-quality parameters (e.g., carbon monoxide (CO), water vapor/moisture (H₂O), carbon dioxide (CO₂), oxygen (O₂), nitrogen (N₂), hydrocarbon, pressure) of air monitoring system 204 by navigating air status tab 504. The array of sensors 104_{1-N} of breathable-air supply system 102 may notify emergency personnel 122_{1-N} through cloud computing network 106 that some fault and/or anomalies (e.g., air contamination, particulates, pollutants, etc.) are detected in one or more unit(s) of breathable-air supply system 102 User interface 550A may help emergency personnel 122_{1-N} view and navigate the air/air-quality parameters of breathable-air supply system 102. Emergency personnel 122_{1-N} may further click on a particular tab showing the detected fault in a particular air parameter (e.g., CO₂) to enable remedial actions to be taken, according to one embodiment.

As shown in ‘(c)’, emergency personnel 122_{1-N} may receive a notification in tab 506 that the parameter is above and/or below predefined threshold values (e.g., CO₂ detected above a predefined threshold value). Emergency personnel 122_{1-N} may also receive a notification in tab 508 to take corrective measures to rectify the fault. Emergency personnel 122_{1-N} may thus be able to take corrective measures and/or actions that are remotely permissible by computing device 120_{1-N} to rectify the fault in breathable-air supply system 102 unit through cloud computing network 106. The corrective measures may include sensor recalibrations, activation and/or deactivation of the actuator control valve, leakage prevention, temperature and pressure management, etc., according to one embodiment. Other corrective measures are within the scope of the exemplary embodiments discussed herein.

FIG. 5B shows another user interface 550B adding interactions (d) to (f) that is arrivable from user interface 550A, according to one embodiment. As shown in ‘(d)’, user interface 550B may show a tab 512 relevant to detection of emergency status 380 and a tab 514 relevant to automatic unlocking of smart lock 118, and an options tab 516. Tab 512 may notify emergency personnel 122_{1-N} that emergency state 380 in a particular breathable-air supply system 102 (e.g., including internal air fill station 202, air storage system 206, etc.) is detected by the array of sensors 104_{1-N}. Tab 514 may notify emergency personnel 122_{1-N} that smart lock 118 associated with breathable-air supply system 102 may unlock one or more location(s) 370 (e.g., each location 370) of breathable-air supply system 102 needed to be accessed by emergency personnel 122_{1-N} during emergency state 380 of building 308.

Emergency personnel 122_{1-N} may select options tab 516 to navigate various options to take corrective measures to rectify the fault, as discussed above. User interface 550B shown in ‘(e)’ displays a sensor recalibration tab 518, a purging tab 520, an activation bypass switch tab 522 and a leakage prevention tab 524 to enable emergency personnel 122_{1-N} take corrective measures remotely.

User interface 550B shown in ‘(f)’ displays a tab 526 relevant to detection of normal state 390, a tab 528 relevant to automatic locking of smart lock 118, a status tab 530, and a video tab 532 Tab 526 may notify emergency personnel 122_{1-N} that emergency state 380 has ended and normal state 390 of building 308 has been detected. Tab 528 may notify emergency personnel 122_{1-N} that smart lock 118 associated with breathable-air supply system 102 has been automatically locked for one or more location(s) 370 (e.g., each location 370) of breathable-air supply system 102 accessed by the emergency personnel 122_{1-N}. Status tab 530 may show whether the fault in breathable-air supply system 102 is rectified or not.

Video tab 532 may enable emergency personnel 122_{1-N} to remotely view visual recording 142 of the one or more location(s) 370 (e.g., each location 370)/components of breathable-air supply system 102 for monitoring thereof, according to one embodiment. All reasonable variations are within the scope of the exemplary embodiments discussed herein.

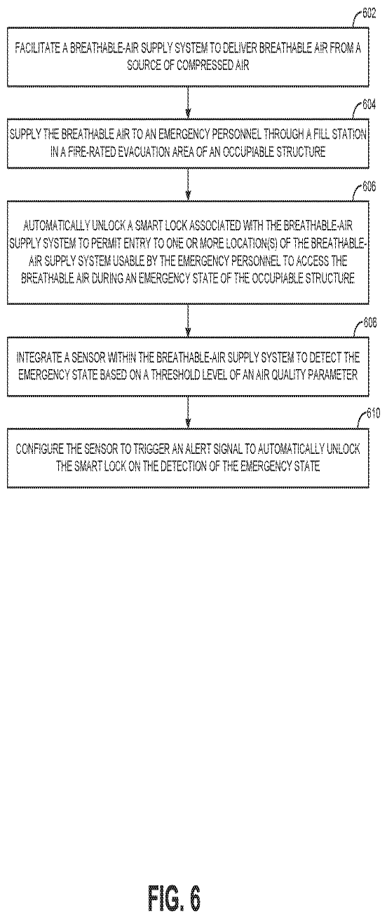

FIG. 6 shows a process flow diagram detailing the operations in a sensor-based smart unlocking of a firefighter air replenishment system (e.g., safety system 150), according to one embodiment. In one or more embodiments, operation 602 may involve facilitating a breathable-air supply system (e.g., breathable-air supply system 102) to deliver breathable air from a source of compressed air (e.g., source of compressed air 170). In one or more embodiments, operation 604 may involve supplying the breathable air to an emergency personnel (e.g., emergency personnel 122_{1-N}) through a fill station (e.g., internal air fill station 202) in a fire-rated evacuation area (e.g., fire-rated evacuation area 350) of an occupiable structure (e.g., building 308).

In one or more embodiments, operation 606 may involve automatically unlocking a smart lock (e.g., smart lock 118) associated with the breathable-air supply system to permit entry to one or more location(s) (e.g., one or more location(s) 370) of the breathable-air supply system usable by the emergency personnel to access the breathable air during an emergency state (e.g., emergency state 380) of the occupiable structure. In one or more embodiments, operation 608 may involve integrating a sensor (e.g., array of sensors 104_{1-N}) within the breathable-air supply system to detect the emergency state based on a threshold level (e.g., first predetermined threshold value, second predetermined threshold value) of an air quality parameter. In one or more embodiments, operation 610 may then involve configuring the sensor to trigger an alert signal (e.g., alert signal 192) to automatically unlock the smart lock on the detection of the emergency state.

The methods and systems disclosed herein may be implemented in any means for achieving various aspects, and may be executed in a form of a non-transitory machine-readable medium embodying a set of instructions that, when executed by a machine, causes the machine to perform any of the operations disclosed herein.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS-based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application-specific integrated (A SIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., computing device 120_{1-N}, cloud computing network 106, the array of sensors 104_{1-N}). Accordingly, the specification and drawings are to be regarded in an illustrative rather than a restrictive sense.

1-32. (canceled)

33. A safety system of an occupiable structure, comprising:
a sensor associated with a breathable-air supply system;
the sensor to detect an emergency state of the occupiable structure and generate a signal to cause a smart lock to unlock at least one location of a fill station in a fire-rated evacuation area of the occupiable structure to supply breathable air from a source of compressed air to an emergency personnel responsive to detection of the emergency state of the occupiable structure;
wherein the emergency state of the occupiable structure corresponds at least one of a level of ambient carbon dioxide, a level of ambient oxygen, a level of nitrogen, a level of ambient carbon monoxide, condensed hydrocarbon, a moisture concentration, a temperature, power parameters, air leakage, or a presence of smoke.

34. The safety system of claim 33, comprising:
the breathable-air supply system to facilitate delivery of the breathable air from the source of compressed air.

35. The safety system of claim 33, comprising:
the fill station.

36. The safety system of claim 33, comprising:
the smart lock associated with the breathable-air supply system to unlock at least one location of the breathable-air supply system.

37. The safety system of claim 33, wherein:
the smart lock associated with the breathable-air supply system locks at least one location of the breathable-air supply system required by the emergency personnel to access the breathable air when the emergency state ends and a normal state of the occupiable structure is detected.

38. The safety system of claim 33, wherein the breathable-air supply system is housed in an air storage sub-system appurtenant to the occupiable structure.

39. The safety system of claim 33, wherein a lock state and an unlock state of the smart lock is determined based on sensor data of the sensor associated with the breathable-air supply system.

40. The safety system of claim 33, comprising:
a video camera to capture at least one of a visual recording or an audio recording of the at least one location of the fill station with the smart lock in an unlocked state.

41. The safety system of claim 33, comprising:
the sensor including a carbon monoxide sensor to trigger the emergency state with the level of ambient carbon monoxide exceeding a first predetermined threshold value.

42. The safety system of claim 33, comprising:
the sensor including an oxygen level sensor that triggers the emergency state with the level of ambient oxygen outside a predetermined range of values.

43. The safety system of claim 33, comprising:
the sensor including a nitrogen level sensor that triggers the emergency state with the level of nitrogen below a first predetermined threshold value or with the level of nitrogen above a second predetermined threshold value.

44. The safety system of claim 33, comprising:
the sensor including a hydrocarbon sensor that triggers the emergency state with the condensed hydrocarbon content exceeding a predetermined threshold value.

45. The safety system of claim 33, comprising at least one of:
the sensor including at least one of a moisture sensor or a pressure sensor.

46. The safety system of claim 33, wherein at least one of:
at least one location of the breathable-air supply system comprises at least one of: an exterior mobile air connection panel, an air monitoring closet, an air monitoring room, an air storage closet, an air storage room, a fire command center, a fire command room, a fire alarm panel, a computing device executing a software application thereon, the fill station of the occupiable structure, and a temporarily established fill station connected to the source of compressed air during the emergency state;
the smart lock associated with the breathable-air supply system unlocks each location of the breathable-air supply system usable during the emergency state of the occupiable structure;
the fire-rated evacuation area of the occupiable structure includes a stairwell; or the sensor comprises an array of sensors.

47. A method, comprising:
integrating a sensor within a breathable-air supply system to detect an emergency state based on a threshold level of an air quality parameter, the breathable air-supply system to deliver breathable air from a source of compressed air; and
configuring the sensor to trigger an alert signal to unlock a smart lock responsive to the detection of the emergency state and generate the alert signal causing the smart lock to unlock at least one location of a fill station in a fire-rated evacuation area of an occupiable structure to supply the breathable air to an emergency personnel through the fill station in the fire-rated evacuation area of the occupiable structure, responsive to detection of the emergency state of the occupiable structure, wherein the emergency state of the occupiable structure corresponds at least one of a level of ambient carbon dioxide, a level of ambient oxygen, a level of nitrogen, a level of ambient carbon monoxide, condensed hydrocarbon, a moisture concentration, a temperature, power parameters, air leakage, or a presence of smoke.

48. The method of claim 47, comprising:
supplying the breathable air to the emergency personnel through the fill station in the fire-rated evacuation area of the occupiable structure; and
unlocking a smart lock associated with the breathable-air supply system to permit entry to at least one location of the breathable-air supply system usable by the emergency personnel to access the breathable air during the emergency state of the occupiable structure.

49. The method of claim 47, comprising:
detecting, by the sensor, a normal state of the occupiable structure; and
locking, responsive to detecting the normal state, at least one location of the breathable air-supply system.

50. The method of claim 47, comprising:
recording, through a video camera, an audiovisual incident to communicate to at least one of: a remote fire command center, an onsite fire command center and a fire command room through a cloud computing network, the audiovisual incident indicating the at least one location of the fill station or at least one location of the breathable-air supply system is accessed by at least one of: an unauthorized person or the emergency personnel in an unlock state of the smart lock.

51. The method of claim 47, comprising:
providing, through the breathable-air supply system, a situational awareness recommendation to at least one of: a remote fire command center, an onsite fire command center and a fire command room using an artificial intelligence algorithm based on a regression analysis of a sensory data of the sensor.

52. A method, comprising:
unlocking a smart lock associated with a breathable-air supply system to permit entry to each location of the breathable-air supply system usable by emergency personnel to access breathable air during an emergency state of an occupiable structure;
integrating a sensor within the breathable-air supply system to detect the emergency state based on a threshold level of an air quality parameter; and
configuring the sensor to trigger an alert signal to unlock the smart lock on the detection of the emergency state and generate the alert signal causing the smart lock to unlock the at least one location of a fill station, responsive to detection of the emergency state of the occupiable structure, wherein the emergency state of the occupiable structure corresponds at least one of a level of ambient carbon dioxide, a level of ambient oxygen, a level of nitrogen, a level of ambient carbon monoxide, condensed hydrocarbon, a moisture concentration, a temperature, power parameters, air leakage, or a presence of smoke.
